(19) United States
(12) Patent Application Publication
(10) Pub. No.: US 2012/0116723 A1
(43) Pub. Date: May 10, 2012

(54) SYSTEM AND METHOD FOR TRANSMITTING DATA FROM A ROTATING COMPONENT

(75) Inventors: Donald W. Shaw, Simpsonville, SC (US); Clay Jeremiah Schile, Seneca, SC (US); Derek Ray Wilson, Greenville, SC (US); Michael Allen Ball, Mauldin, SC (US)

(73) Assignee: GENERAL ELECTRIC COMPANY, Schenectady, NY (US)

(21) Appl. No.: 12/941,337

(22) Filed: Nov. 8, 2010

(51) Int. Cl. G06F 15/00

(52) U.S. Cl. 702/188

(57) ABSTRACT

A system for transmitting data from a rotating component includes sensors on the rotating component, wherein each of the sensors detects at least one characteristic of the rotating component and transmits a signal reflective of the characteristic. Data slip rings are in communication with the sensors, and a signal conditioning circuit between the sensors and the data slip rings converts each of the signals from the sensors into a digital signal. A method for transmitting data from a rotating component includes sensing a characteristic of the rotating component using sensors and generating a signal from each of the sensors reflective of the characteristic of the rotating component. The method further includes converting each of the signals to a digital signal and transferring each of the digital signals from the rotating component through a plurality of data slip rings.

### FIELD OF THE INVENTION

The present invention generally involves a system and method for transmitting data from a rotating component. In particular embodiments, the system and method may provide power to sensors on the rotating component.

### BACKGROUND OF THE INVENTION

Numerous machines include rotating components. For example, wind turbines, gas turbines, steam turbines, pumps, fans, generators, motors, and other forms of commercial equipment frequently include shafts, blades, and other rotating components. It is known in the art to install one or more sensors on the rotating components to measure various characteristics of the rotating components to control, monitor, and/or enhance the operation of the rotating components. For example, sensors that measure the temperature, velocity, stress, strain, vibrations, and/or other characteristics of the rotating components may allow for early detection of abnormalities, adjustments to repair or maintenance schedules, and/or other actions to enhance operations.

Various slip ring and telemetry systems are known in the art for transmitting the sensor data from the rotating components to stationary components for further analysis. In a slip ring system, for example, the analog sensor data may be transmitted through slip rings to a stationary data acquisition circuit. However, the volume of analog data that can be transferred through each slip ring is relatively limited compared to the number of sensors that may exist on each rotating component. A telemetry system, on the other hand, may include circuitry on the rotating component that packages the sensor data into a compressed data stream. A transmitter on the rotating component may then transmit the compressed data stream from the rotating component to a nearby stationary loop antenna. In this manner, each transmitter in the telemetry system may transmit larger volumes of sensor data than could be transmitted through slip rings.

Although telemetry systems generally provide increased data transmission capabilities compared to conventional slip ring systems, telemetry systems also have their limitations. A separate transmitter is typically required for each type of sensor, and the transmitter and loop antenna components are generally more expensive than the components used in a slip ring system. The amount of power that can be supplied through the loop antenna to the sensors is somewhat limited due to the inherent problems associated with inductive coupling between the loop antenna and the transmitters. In addition, a specific geometry is required between the loop antenna and the transmitters to ensure reliable communications. Vibrations, electromagnetic interference, and other effects inherently present with rotating components may interfere with the specific geometry and result in dropped data between the transmitters and loop antenna.

As a result, continued improvements in the systems and methods for transferring data from rotating components would be useful.

### BRIEF DESCRIPTION OF THE INVENTION

Aspects and advantages of the invention are set forth below in the following description, or may be obvious from the description, or may be learned through practice of the invention.

One embodiment of the present invention is a system for transmitting data from a rotating component. The system includes a plurality of sensors on the rotating component, wherein each of the plurality of sensors detects at least one characteristic of the rotating component and transmits a signal reflective of the characteristic. A plurality of data slip rings are in communication with the plurality of sensors, and a signal conditioning circuit between the plurality of sensors and the plurality of data slip rings converts each of the signals from the plurality of sensors into a digital signal.

Another embodiment of the present invention is a system for transmitting data from a rotating component. The system includes a plurality of sensors on the rotating component, wherein the plurality of sensors detect a plurality of characteristics of the rotating component and transmit a plurality of signals reflective of the plurality of characteristics. A plurality of data slip rings are in communication with the plurality of sensors, and a signal conditioning circuit between the plurality of sensors and the plurality of data slip rings converts the plurality of signals into a plurality of digital signals.

The present invention also includes a method for transmitting data from a rotating component. The method includes sensing a characteristic of the rotating component using a plurality of sensors and generating a signal from each of the plurality of sensors reflective of the characteristic of the rotating component. The method further includes converting each of the signals to a digital signal and transferring each of the digital signals from the rotating component through a plurality of data slip rings.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of a portion of a system according to one embodiment of the present invention; and

FIG. 2 is a perspective view of another portion of the system shown in FIG. 1.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Embodiments of the present invention provide a system and method for transmitting data from a rotating component. The system and method employ one or more conditioning circuits to digitize, multiplex, and/or stream a plurality of data signals from multiple sensors through slip rings to a data acquisition circuit. The conditioning circuits may be programmed to receive data signals from virtually any sensor selected to measure characteristics of a rotating component. Particular embodiments may further include a circuit board connector to facilitate interconnection, substitution, replacement, or interchangeability of the sensors. A data acquisition circuit may be located remote from the rotating component to further process, record, and analyze the data signals for subsequent use in testing, controlling operations, repair, and/or maintenance of the rotating component. In addition, the slip rings may provide a convenient and reliable method for supplying power to the sensors.

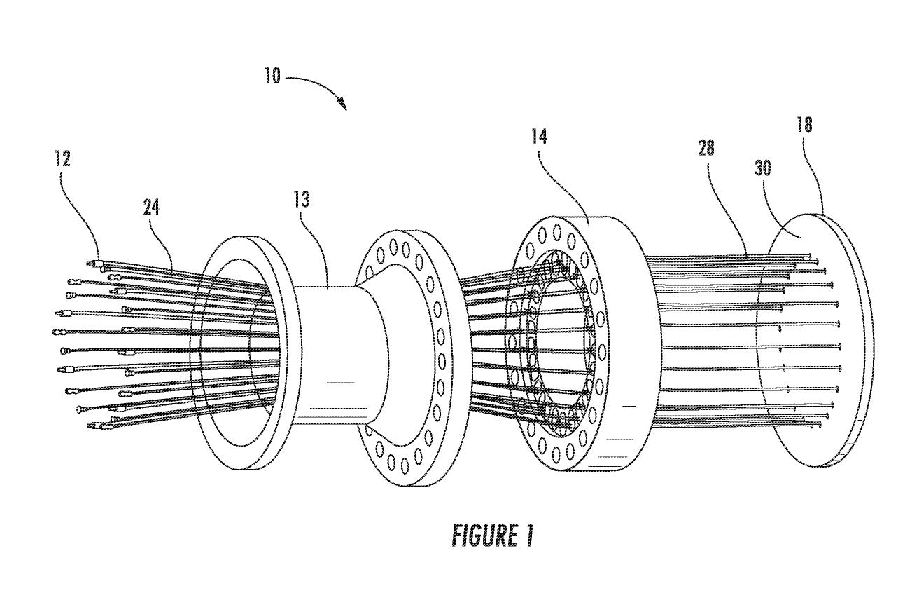

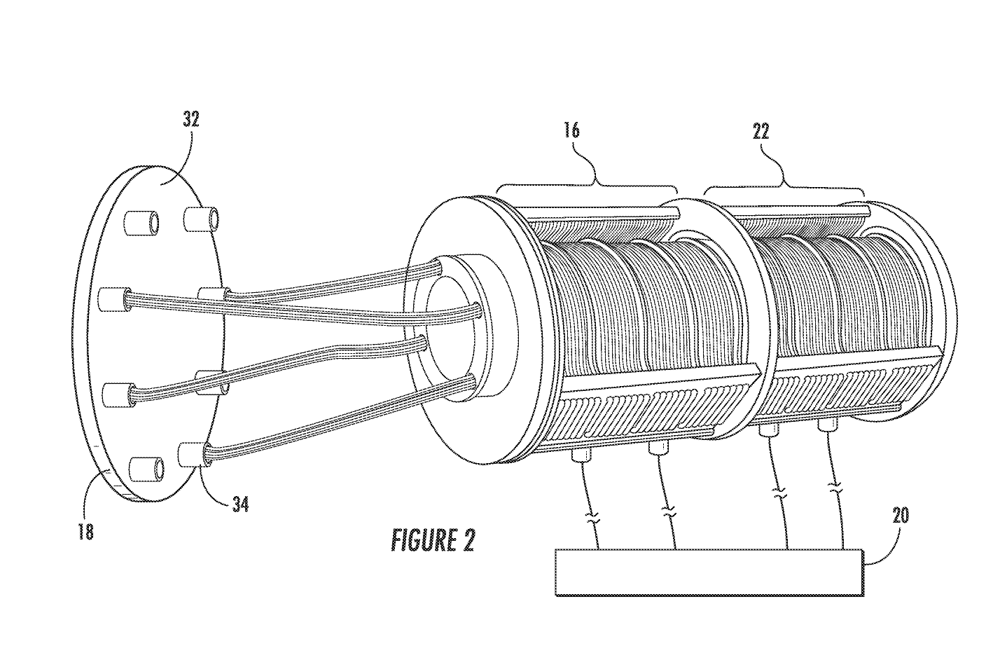

FIGS. 1 and 2 provide a simplified perspective view of a system 10 according to one embodiment of the present invention. The system 10 generally includes a plurality of sensors 12, one or more signal conditioning circuits 14, and a plurality of data slip rings 16. Particular embodiments may further include a circuit board connector 18, a data acquisition circuit 20, and a plurality of power slip rings 22.

The sensors 12 are located on a rotating component 13 and monitor one or more characteristics on the rotating component 13. The rotating component 13 may comprise virtually anything that rotates or reciprocates. For example, the rotating component 13 may be a rotor, shaft, impeller, compressor blade, turbine blade, or any other component that rotates or reciprocates. The sensors 12 may comprise pressure detectors, strain gauges, or accelerometers that generate one or more signals 24 reflective of vibrations or movement by the compressor blades, turbine blades, or other rotating components. In this manner, the characteristics detected by the sensors 12 may be used to determine the optimum or sub optimum flows that minimize or increase vibrations in the blades or rotating components, as desired. In other embodiments, the sensors 12 may comprise thermocouples or resistance temperature detectors that generate one or more signals 24 reflective of the temperature of the various rotating components. In this manner, the characteristics detected by the sensors 12 may be used to improve the efficiency, detect abnormalities, and/or monitor operations of the rotating component 13. One of ordinary skill in the art will readily appreciate that embodiments of the present invention are not limited to any particular sensor unless specifically recited in the claims.

The signal conditioning circuit 14 is generally located between the sensors 12 and the data slip rings 16. Particular embodiments may include a separate signal conditioning circuit for each type (e.g., strain gauge, thermocouple, etc.) of sensor 12. The signal conditioning circuit 14 receives the signals 24 generated by the sensors 12 and processes or formats the signals 24 for transmission across the data slip rings 16. For example, the signal conditioning circuit 14 may receive multiple analog signals 24 from the sensors 12 and convert the analog signals 24 into a digital signal, binary signal, or other base system formatted signal. The signal conditioning circuit 14 may further multiplex multiple digitized signals into a single stream of digital data. For example, the signal conditioning equipment may convert thermocouple signals 24 to a digital value of 0-2.3 volts and strain gauge signals 24 to a digital value of 2.6-5 volts. The signal conditioning circuit 14 may then multiplex the multiple digitized signals from multiple types of sensors 12 into a single stream of alternating data formats for transmission through the data slip rings 16. In this manner, a single stream of data transmitted through a single data slip ring may include information from multiple sensors 12 at multiple locations.

The signal conditioning circuit 14 may further be programmed to determine the sample rate of each particular sensor 12. For example, temperature is generally a relatively slow changing characteristic compared to pressure or vibrations. As a result, the signal conditioning circuit 14 may be programmed to sample the signal 24 from the temperature sensors 12 at a much lower frequency than the sample rate of the signals 24 from the pressure sensors 12. In addition, sensors 12 on particular regions of the rotating component 13 may require different sample rates. For example, shorter compressor or turbine blades vibrate at a substantially higher frequency than longer compressor or turbine blades. Accordingly, the signal conditioning circuit 14 may be programmed to sample signals 24 from pressure sensors 12 attached to the shorter compressor or turbine blades more often than those attached to the longer compressor or turbine blades.

As described herein, the signal conditioning circuit 14 may comprise hardwired logic, a processor, microprocessor, controller, microcontroller, or other embedded circuitry adapted in any suitable manner to provide the desired functionality. For instance, one or more processors may be adapted to provide the described functionality by responding to commands sent by the user through control software. However, the signal conditioning circuit 14 discussed herein is not limited to any particular hardware or software architecture or configuration, and a different signal conditioning circuit 14 may be used for each type of sensor 12 being used. For example, as will be understood by those of ordinary skill in the art without required additional detailed discussion, some systems and methods set forth and disclosed herein may also be implemented by hard-wired logic or other circuitry, including, but not limited to, application-specific circuits. Of course, various combinations of computer-executed software and hard-wired logic or other circuitry may be suitable as well.

As shown in FIGS. 1 and 2, the circuit board connector 18 between the signal conditioning circuit 14 and the plurality of data slip rings 16 may act in concert with the signal conditioning circuit 14 to organize and direct the data streams to specific data slip rings 16. For example, as shown in FIG. 1, the signal conditioning circuit 14 produces multiple data streams 28, and each data stream 28 may in turn include information from multiple sensors 12. Each data stream 28 connects to a first side 30 of the circuit board connector 18, and internal wiring in the circuit board connector 18, which may simply be a wire harness, reroutes and organizes the incoming data streams 28 to a second side 32 of the circuit board connector 18. As shown in FIG. 2, the second side 32 of the circuit board connector 18 may include pigtails, bundles 34, or other structure for collecting or segregating wires to facilitate connecting the wires to specific data slip rings 16. For example, if desired, the circuit board connector 18 may organize data streams 28 according to sensor 12 type, location on the rotating component 13, or any other discriminator selected by an operator.

The data slip rings 16 provide the means for transmitting data from the rotating component 13. Each data slip ring 16 comprises a conductive circle or band that rotates with the rotating component 13. The electrical connection between the sensors 12 and the data slip rings 14 allows for data to be continuously communicated from the sensors 12 through the data slip rings 16. Static brushes or wires in contact with the data slip rings 16 complete the circuit to allow the data to be transmitted off of the rotating component 13. One of ordinary skill in the art can readily appreciate that the data rate transfer may be increased in multiples by dividing each slip ring 16 into a plurality of conductive segments. For example, four independent data streams 28 may be transmitted through a data slip ring 16 having four conductive segments; eight independent data streams 28 may be transmitted through a data slip ring 16 having eight conductive segments; and so forth. Additional power slip rings 22 may be used to provide or transfer electricity into the rotating component 13. In this manner, the power slip rings 22 may be used to supply power through the signal conditioning circuit 14 to the sensors 12. One of ordinary skill in the art will readily appreciate that the electrical connection between the brushes and the data and power slip rings 16, 22 is substantially more secure and less sensitive to noise, changes in geometry, and the other factors that limited the reliability and power transfer of telemetry systems.

As shown in FIG. 2, the data acquisition circuit 20 is connected to the plurality of data and power slip rings 16, 22 to receive the data streams 28 from the signal conditioning circuit 14. The data acquisition circuit 20 generally functions as a de-multiplexer or decoder to remove the individual sensor signals 24 from the data stream 28 produced by the signal conditioning circuit 14. As the data acquisition circuit 20 is not located on the rotating component 13, it may readily be located on a stationary component remote from the rotating component 13.

One of ordinary skill in the art will readily appreciate that the system 10 described illustrated with respect to FIGS. 1 and 2 may provide a method for transmitting data from the rotating component. The method generally includes sensing a characteristic of the rotating component using the plurality of sensors 12 and generating the signal 24 from each of the plurality of sensors 12 reflective of the characteristic of the rotating component. The method further includes converting each of the signals 22 to digital signals 24 and transferring each of the digital signals 24 from the rotating component through the plurality of data slip rings 16. In particular embodiments, the method may further include sensing the plurality of characteristics of the rotating component using the plurality of sensors 12 and generating the plurality of signals 22 reflective of the characteristics. In addition, the signal conditioning circuit 14 may multiplex the plurality of signals 22 reflective of the characteristics. The plurality of signals 22 may thus be transferred to the data acquisition circuit 20 through the data slip rings 16 and remote from the rotating component.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal languages of the claims.

What is claimed is:

1. A system for transmitting data from a rotating component comprising:
a. a plurality of sensors on the rotating component, wherein each of said plurality of sensors detects at least one characteristic of the rotating component and transmits a signal reflective of said characteristic;
b. a plurality of data slip rings in communication with said plurality of sensors; and
c. a signal conditioning circuit between said plurality of sensors and said plurality of data slip rings, wherein said signal conditioning circuit converts each of said signals from said plurality of sensors into a digital signal.

2. The system as in claim 1, wherein said plurality of sensors comprise at least one of a thermocouple, a strain gauge, a resistance temperature detector, a pressure gauge, or an accelerometer and combinations thereof.

3. The system as in claim 1, wherein said plurality of sensors detect a plurality of characteristics of the rotating component and transmit a plurality of signals reflective of said characteristics.

4. The system as in claim 1, wherein said signal conditioning circuit multiplexes each of said signals from said plurality of sensors.

5. The system as in claim 1, further comprising a circuit board connector between said signal conditioning circuit and said plurality of data slip rings.

6. The system as in claim 1, further comprising a data acquisition circuit in communication with said plurality of data slip rings, wherein said data acquisition circuit receives said digital signals.

7. The system as in claim 6, wherein said data acquisition circuit is remote from the rotating component.

8. The system as in claim 1, further comprising a plurality of power slip rings in communication with said plurality of sensors, wherein said plurality of power slip rings supply electrical power to said plurality of sensors.

9. A system for transmitting data from a rotating component comprising:
a. a plurality of sensors on the rotating component, wherein said plurality of sensors detect a plurality of characteristics of the rotating component and transmit a plurality of signals reflective of said plurality of characteristics;
b. a plurality of data slip rings in communication with said plurality of sensors; and
c. a signal conditioning circuit between said plurality of sensors and said plurality of data slip rings, wherein said signal conditioning circuit converts said plurality of signals into a plurality of digital signals.

10. The system as in claim 9, wherein said plurality of sensors comprise at least one of a thermocouple, a strain gauge, a resistance temperature detector, a pressure gauge, or an accelerometer and combinations thereof.

11. The system as in claim 9, wherein said signal conditioning circuit multiplexes said plurality of signals.

12. The system as in claim 9, further comprising a circuit board connector between said signal conditioning circuit and said plurality of data slip rings.

13. The system as in claim 9, further comprising a data acquisition circuit in communication with said plurality of data slip rings, wherein said data acquisition circuit receives said plurality of digital signals.

14. The system as in claim 13, wherein said data acquisition circuit is remote from the rotating component.

15. The system as in claim 9, further comprising a plurality of power slip rings in communication with said plurality of sensors, wherein said plurality of power slip rings supply electrical power to said plurality of sensors.

16. A method for transmitting data from a rotating component comprising:
a. sensing a characteristic of the rotating component using a plurality of sensors;
b. generating a signal from each of said plurality of sensors reflective of the characteristic of the rotating component;
c. converting each of said signals to a digital signal; and
d. transferring each of said digital signals from the rotating component through a plurality of data slip rings.

17. The method as in claim 16, further comprising sensing a plurality of characteristics of the rotating component using the plurality of sensors and generating a plurality of signals reflective of said characteristics.

18. The method as in claim 17, further comprising multiplexing said plurality of signals reflective of said characteristics.

19. The method as in claim 16, further comprising transferring each of said digital signals to a data acquisition circuit in communication with said plurality of data slip rings and remote from the rotating component.

20. The method as in claim 16, further comprising transferring electrical power through a plurality of power slip rings to said plurality of sensors.
